(19) United States
(12) Patent Application Publication
(10) Pub. No.: US 2025/0321515 A1
(43) Pub. Date: Oct. 16, 2025

(54) SWITCH DEVICE FOR TONER PORT OF TONER CONTAINER

(71) Applicant: BEIJING XINTRON OFFICE EQUIPMENT CO., LTD., Beijing (CN)

(72) Inventors: Haifeng Geng, Beijing (CN); Xuewen Ma, Beijing (CN)

(21) Appl. No.: 18/579,431

(22) PCT Filed: Sep. 22, 2021
(86) PCT No.: PCT/CN2021/119500

§ 371 Date: Jul. 2, 2025

(30) Foreign Application Priority Data
Jul. 15, 2021 (CN) 202110802003.7

(51) Int. Cl. G03G 15/08; G03G 21/16

(52) U.S. Cl. CPC G03G 15/0886; G03G 21/1647; G03G 2215/0692; G03G 2221/163

(57) ABSTRACT

A switch device for a toner port of a toner container includes a base (1) for accommodating the toner container, the base (1) having a toner outlet (1-7); a rotating block (3) having a toner discharge channel (3-1), wherein the rotating block (3) is rotatably coupled to the base (1); and a driving sliding plate (6), which is able to drive the rotating block (3) to rotate. The toner port of the toner container is opened when the rotating block (3) rotates to a position where the toner discharge channel (3-1) communicates with the toner outlet (1-7), and the toner port of the toner container is closed when the toner discharge channel (3-1) does not communicate with the toner outlet (1-7). The switch device has a simple structure, is able to be smoothly installed, and protects the internal installation structure of the machine.

### BACKGROUND OF THE PRESENT INVENTION

### Field of Invention

The present application relates to the technology field of a driving switch for a toner port of a toner feeding container, and more specifically, to a switch device for a toner port of a toner container.

### Description of Related Arts

A toner container is an important accessory for a printer and a copy, especially, whether the opening and closing of a toner port is smooth may affect the print quality. The Patent No. U.S. Pat. No. 10,209,667 B2 of Canon Corporation of Japan discloses a toner container, which has the following shortcomings. (1) The structure of the toner port of the toner container is relatively complex, and there may be a feeling of jamming during the installation and removal processes of the toner container. (2) The structure of the toner container involves many slender plastic parts, and deformation of fine plastic parts during operation may affect the normal installation or removal of the toner container. (3) Since many installation parts of the toner container have slender structures with high production and storage requirements, the deformation of the slender structures may affect the assembly and machine installation effects, and may damage the internal structure of the machine in serious cases. (4) During the first installation and removal process, if the switch slider is abnormal and is unable to be restored to its original position, it will affect subsequent installation. Moreover, users generally do not know the operating principle during use, and forced installation may damage the machinery equipment.

### SUMMARY OF THE PRESENT INVENTION

In view of the problems in the prior art, the present application proposes a switch device for a toner port of a toner container. The switch device comprises a base for accommodating the toner container, wherein the base has a toner outlet; a rotating block having a toner discharge channel, wherein the rotating block is rotatably coupled to the base; and a driving sliding plate for driving the rotating block to rotate, wherein the toner port of the toner container is opened when the rotating block rotates to a position where the toner discharge channel communicates with the toner outlet, and the toner port of the toner container is closed when the toner discharge channel does not communicate with the toner outlet.

Preferably, the switch device further comprises a connecting rod, which has a first end coupled to the rotating block for driving the rotating block to rotate and a second end connected to the driving sliding plate.

Preferably, the switch device further comprises a compressed sealing cotton piece, which is attached on the rotating block, has a first toner discharge hole, and is located between the base and the rotating block after installation, wherein the first toner discharge hole is coaxial with the toner discharge channel of the rotating block.

Preferably, the driving sliding plate has a slide groove, the base comprises a slide rail, and the slide rail is inserted into the slide groove to achieve sliding fit.

Preferably, the switch device further comprises a return spring, which is arranged between a second spring holding plate of the driving sliding plate and a first spring holding plate of the base, and is compressed when the driving sliding plate slides.

Preferably, the switch device further comprises a fixed cover plate, which is engaged with the base and has a second toner discharge hole, wherein a compressed sealing cotton piece, the rotating block, a connecting rod and the driving sliding plate are located between the fixed cover plate and the base, and the second toner discharge hole of the fixed cover plate is coaxial with the toner outlet of the base.

Preferably, the rotating block comprises a rotating block plate part, and the toner outlet of the base is closed by the rotating block plate part when the rotating block rotates to a position where the toner discharge channel does not communicate with the toner outlet of the base so as to achieve closing the toner port of the toner container.

Preferably, the driving sliding plate has a first holding portion, at which the driving sliding plate is driven to slide when the toner container is loaded.

Preferably, the rotating block has a circular shape, a fanned shape, a V-shape or other irregular shapes.

Preferably, the return spring is compressed when the toner container is loaded, and the return spring is reset when the toner container is removed.

The beneficial effects of the present application are smooth installation and protection of the internal installation structure of the machine. When the toner container is removed from the machine, the toner port is closed automatically. Compared with the prior art, the structure and shape of the switch device is simplified, the production process requirements are lower, and the failure rate is low.

### BRIEF DESCRIPTION OF THE DRAWINGS

In order that the present application may be understood more easily, the present application is described in more detail with reference to specific implementations with the accompanying drawings. These drawings depict only typical implementations of the present application and should not be considered as limiting the scope of the present application.

FIG. 1 is a perspective view of a base of a switch device according to the present application.

FIG. 2 is a perspective view of a compressed sealing cotton piece of the switch device according to the present application.

FIG. 3 is a perspective view of a rotating block of the switch device according to the present application.

FIG. 4 is a perspective view of a connecting rod of the switch device according to the present application.

FIG. 5 is a perspective view of a return spring of the switch device according to the present application.

FIG. 6 is a perspective view of a driving sliding plate of the switch device according to the present application.

FIG. 7 is a perspective view of a fixed cover plate of the switch device according to the present application.

FIG. 8 is a perspective view of a screw of the switch device according to the present application.

FIG. 9 is a perspective view of an assembled and installed main structure of the switch device according to the present application, in which a toner outlet is not opened.

FIG. 10 is a perspective view of the assembled and installed main structure of the switch device according to the present application, in which the toner outlet is in a process of being opened.

FIG. 11 is a perspective view of the assembled and installed main structure, in which the toner outlet is opened.

FIG. 12 is a cross-sectional view of the assembled main structure of FIG. 9, corresponding to FIG. 9 in which the toner outlet is not opened.

FIG. 13 is a cross-sectional view of the assembled main structure of FIG. 10, corresponding to FIG. 10 in which the toner outlet is in the process of being opened.

FIG. 14 is a cross-sectional view of the assembled main structure of FIG. 11, corresponding to FIG. 11 in which the toner outlet is opened.

FIG. 15 is a perspective view of the rotating block installed on the assembly diagram.

FIG. 16 is a perspective view of the connecting rod installed on the rotating block.

FIG. 17 is a perspective view of the return spring installed on the base.

FIG. 18 is a perspective view of the driving sliding plate installed on the base.

FIG. 19 is an exploded view of the switch device according to the present application.

FIG. 20 is a perspective view of the fixed cover plate installed on the base.

FIG. 21 is a partial cross-sectional view of FIG. 20 after installation.

FIG. 22 is an exploded view of the switch device according to the present application with the toner container installed together.

FIG. 23 is a schematic diagram of the toner container and an internal structure of a machine without outer casing.

FIG. 24 is a schematic diagram of the toner container and the internal structure of the machine from another perspective without outer casing.

FIGS. 25-27 are perspective views of multiple implementations of the rotating block of the switch device according to the present application.

### REFERENCE NUMBERS

1: base; 1-1: buckle hole; 1-2: first column; 1-3: slide rail; 1-4: first screw hole; 1-5: first spring holding plate; 1-6: second column; 1-7: toner outlet; 1-8: spring groove; 2: compressed sealing cotton piece; 2-1: first toner discharge hole; 2-2: axial hole; 3: rotating block; 3-1: toner discharge channel; 3-2: sliding positioning hole; 3-3: connecting rod column; 3-4: rotating block plate part; 4: connecting rod; 4-1: driving sliding plate hole; 4-2: rotating block hole; 5: return spring; 6: driving sliding plate; 6-1: slide groove; 6-2 first holding portion; 6-3: second holding portion; 6-4: second spring holding plate; 6-5: third column; 6-6: trough; 7: fixed cover plate; 7-1: buckle; 7-2: first insert hole; 7-3: second toner discharge hole; 7-4: second insert hole; 7-5: pressing plane; 7-6: second screw hole; 8: self-tapping screw; 9: driving sliding plate holding portion.

### DETAILED DESCRIPTION OF THE PREFERRED EMBODIMENT

The implementations of the present application are described below with reference to the accompanying drawings, so that those skilled in the art are able to better understand the present application and implement it. However, the enumerated embodiments are not intended to limit the present application. In the absence of conflict, the following embodiments and the technical features in the embodiments are able to be combined with each other, and the same components are denoted by the same reference numbers.

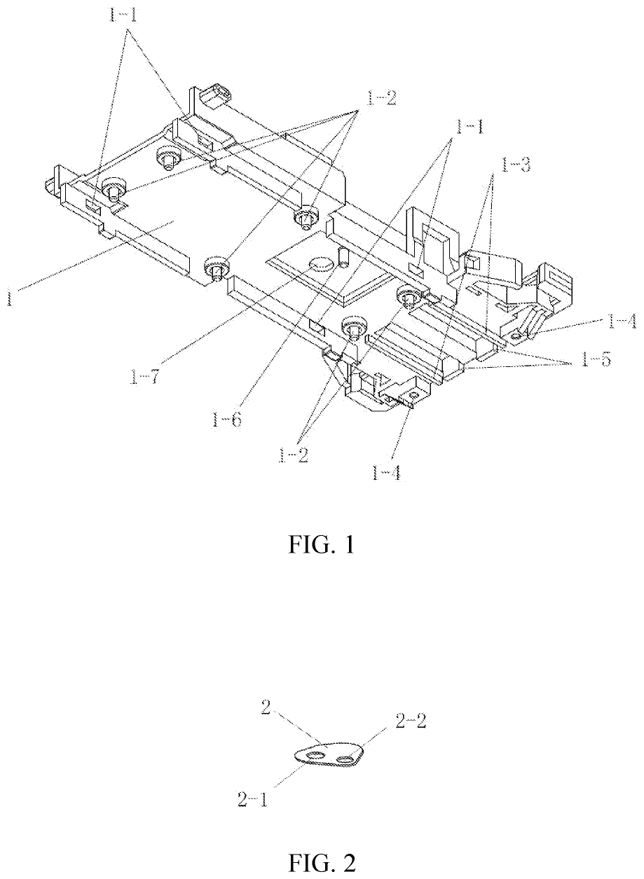

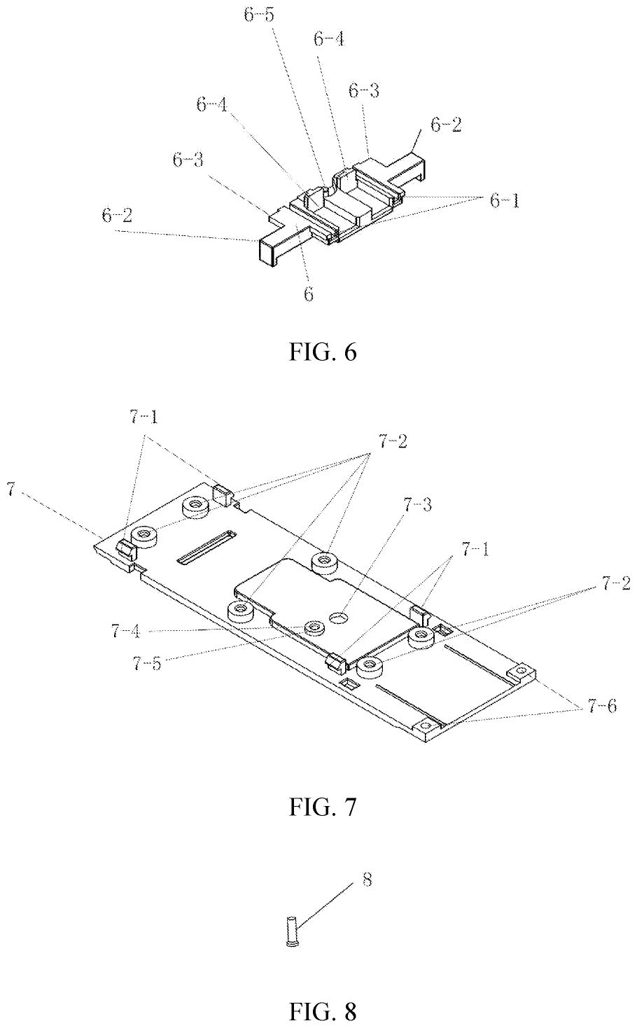

As shown in FIG. 1, a switch device for a toner port of a toner container according to the present application comprises a base 1, a compressed sealing cotton piece 2, and a rotating block 3. The base 1 has a toner outlet 1-7, and a second column 1-6 is provided next to the toner outlet 1-7. The toner outlet 1-7 defines a first channel of the toner container for outputting toner outwards. The base 1 has two spring grooves 1-8 at a bottom thereof for accommodating two return springs 5, respectively. A first spring holding plate 1-5 is against one end of each of the return springs 5. Two slide rails 1-3 are set on the bottom of the base 1 for fitting with two slide grooves 6-1 of a driving sliding plate 6 respectively (referring to FIG. 6).

FIG. 2 is a structurally schematic diagram of the compressed sealing cotton piece 2. The compressed sealing cotton piece 2 has a shape similar to a triangle, while a circumference thereof is smooth arc-shaped. The compressed sealing cotton piece has a first toner discharge hole 2-1 and an axial hole 2-2. The compressed sealing cotton piece 2 is installed under the base 1, the first toner discharge hole 2-1 is aligned with the toner outlet 1-7, and the second column 1-6 is inserted into the axial hole 2-2.

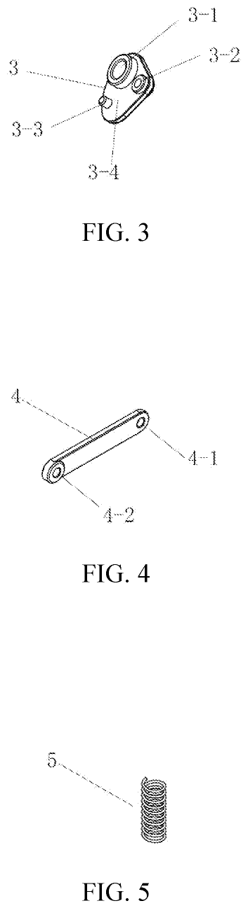

FIG. 3 is a structurally schematic diagram of the rotating block 3. The rotating block 3 also has a shape similar to a triangle.

Preferably, the compressed sealing cotton piece 2 is attached to the rotating block 3, and the rotating block 3 is located below the compressed sealing cotton piece 2 and then installed below the base 1. Preferably, the base 1 has a notch for accommodating the rotating block 3. The shape of the compressed sealing cotton piece 2 is preferably the same as that of the rotating block 3. The first toner discharge hole 2-1 of the compressed sealing cotton piece 2 is coaxial with a toner discharge channel 3-1, which has a certain height, of the rotating block 3.

The rotating block 3 comprises a rotating block plate part 3-4. The toner discharge channel 3-1, a sliding positioning hole 3-2 and a connecting rod column 3-3 are provided on the rotating block plate part 3-4. The first toner discharge hole 2-1 is coaxial with the toner discharge channel 3-1, i.e., after the compressed sealing cotton piece 2 is installed, the toner discharge channel 3-1, the first toner discharge hole 2-1 and the toner outlet 1-7 are coaxial (referring to FIG. 12). The second column 1-6 passes through the axial hole 2-2 and the sliding positioning hole 3-2 to connect the rotating block 3 with the base 1, and the sliding positioning hole 3-2 is in sliding fit with the second column 1-6. The connecting rod column 3-3 passes through a rotating block hole 4-2 of a connecting rod 4 (referring to FIG. 4 and FIG. 16). The axial hole 2-2 is coaxial with the sliding positioning hole 3-2.

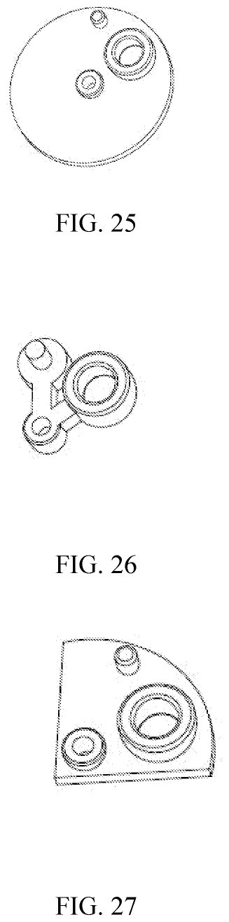

The rotating block 3 may also be other shapes, such as circular, fan-shaped and V-shaped, as shown in FIGS. 25-27, as long as the rotating block 3 is able to rotate, discharge toner and block toner. It should be noted that, as shown in FIG. 26, the rotating block plate part 3-4 is V-shaped, wherein the toner discharge channel 3-1 is provided on one branch of the rotating block plate part 3-4, and no hole is provided in the other branch so that the toner outlet 1-7 is blocked.

FIG. 4 is a structurally schematic diagram of the connecting rod 4. The connecting rod 4 has the rotating block hole 4-2 and a driving sliding plate hole 4-1 at two ends thereof, respectively. As mentioned above, the rotating block hole 4-2 is fitted rotatably with the connecting rod column 3-3 (referring to FIG. 16), and the driving sliding plate hole 4-1 is fitted rotatably with a third column 6-5 of the driving sliding plate 6 (referring to FIG. 6 and FIG. 18). In this way, when the driving sliding plate 6 slides left and right, the connecting rod 4 is driven to slide left and right for driving the rotating block 3 to swing forward and backward, so that the toner outlet 1-7 is switched between an open state and a closed state.

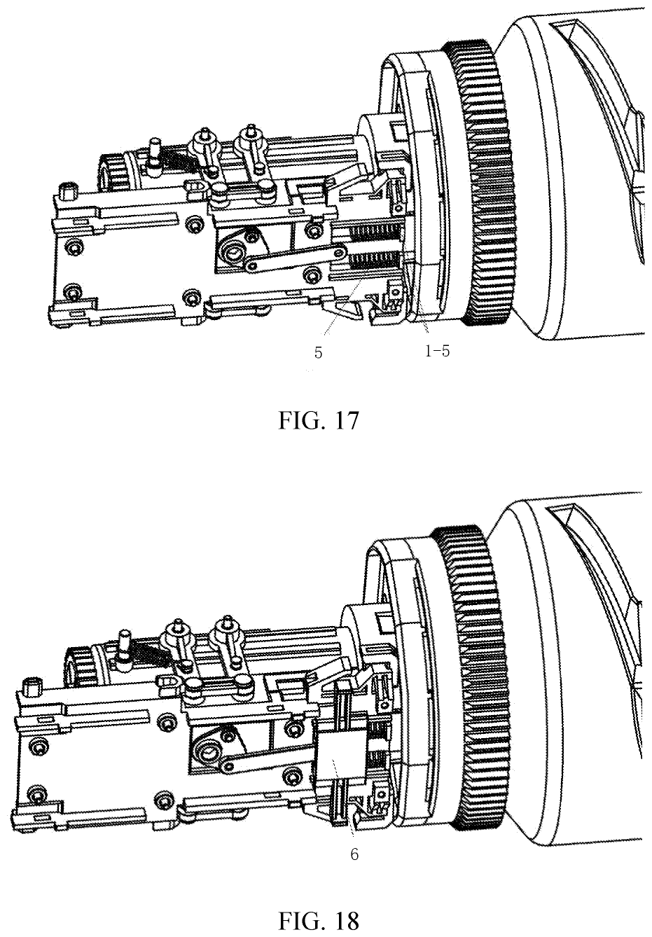

FIG. 5 is a structurally schematic diagram of one return spring 5. Two ends of each of the return springs 5 are fitted with the first spring holding plate 1-5 (referring to FIG. 1) at the bottom of the base 1 and a second spring holding plate 6-4 (referring to FIG. 6),respectively. FIG. 17 shows the return springs 5 after installation.

FIG. 6 is a structurally schematic diagram of the driving sliding plate 6. The driving sliding plate has two troughs 6-6 in a middle thereof. One end of each of the troughs 6-6 is provided with the second spring holding plate 6-4, and the second spring holding plate 6-4 cooperates with the first spring holding plate 1-5 so that each of the return springs 5 is compressed or extended therebetween. As shown in FIGS. 16-18, after the installation is completed, the driving sliding plate 6 is engaged with the base 1 in a manner of sliding. In one embodiment, the driving sliding plate 6 has a slide groove 6-1. One slide rail 1-3 of the base 1 is inserted into the slide groove 6-1 and is able to slide left and right. Alternatively, the slide rail may be provided on the driving sliding plate 6, and the slide groove may be provided on the base 1. The third column 6-5 of the driving sliding plate is fitted rotatably with the driving sliding plate hole 4-1 of the connecting rod 4, and the structure after installation is shown in FIG. 18. Preferably, two return springs 5, two second spring holding plates 6-4 and two first spring holding plates 1-5 are provided to increase the spring return force.

In this way, during the pushing process of the toner container, the driving sliding plate 6 is driven to move by the reverse force of the internal structure of the machine opposite to the pushing direction, the return springs 5 are compressed, the driving sliding plate 6 drives the connecting rod 4 to move, and the rotating block 3 rotates, so that the toner discharge channel 3-1 communicates with the toner outlet 1-7, thereby realizing toner discharging.

On the contrary, when the toner container is taken out from the machine, under an action of elastic force of the return springs 5, the driving sliding plate 6 is driven to pull the connecting rod 4 for rotating the rotating block 3, so that the toner discharge channel 3-1 does not communicate with the toner outlet 1-7, thereby closing the toner outlet of the toner container.

The present application has beneficial effects of smooth installation, protection of the internal installation structure of the machine, and automatic closing of the toner outlet upon removing the toner container from the machine. At the same time, the structure and shape are simple, the production process requirements are lower, and the failure rate is low.

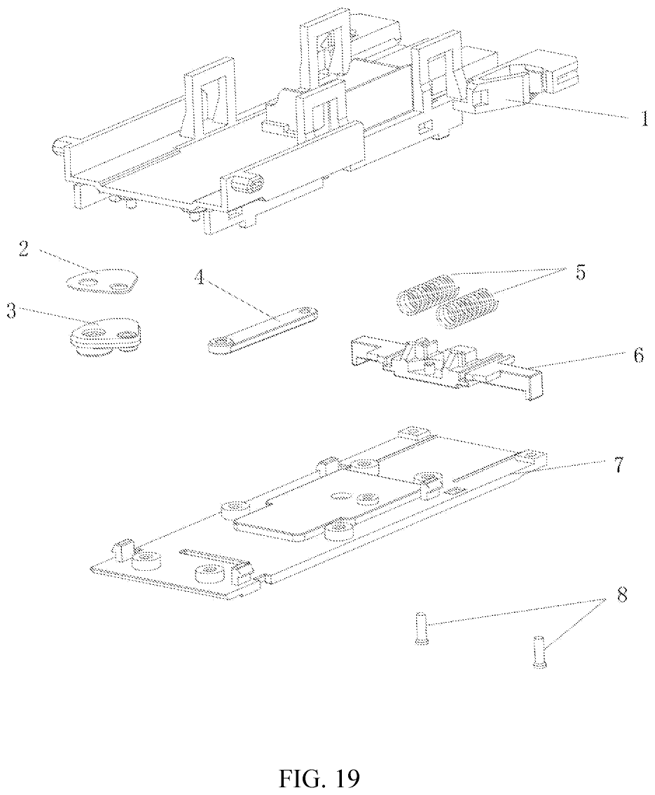

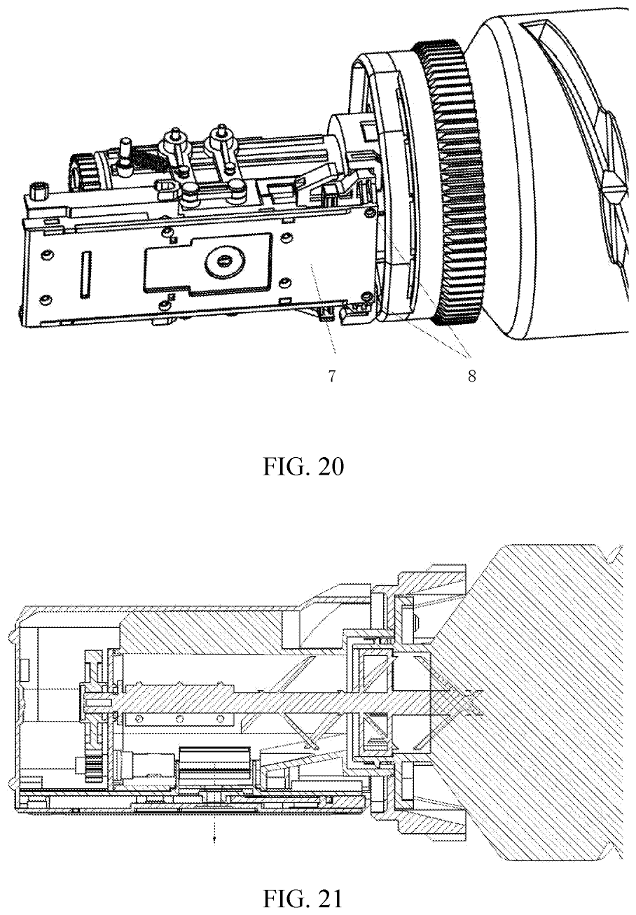

Preferably, the switch device according to the present application further comprises a fixed cover plate 7. FIG. 7 is a structurally schematic diagram of the fixed cover plate 7. Multiples buckles 7-1 of the fixed cover plate 7 are engaged with multiple buckle holes 1-1 of the base 1, respectively. Multiple first columns 1-2 of the base 1 are inserted into multiple first insert holes 7-2 of the fixed cover plate 7, respectively. Six first columns and six first insert holes are shown in figures. The second column 1-6 of the base 1 is inserted into a second insert hole 7-4 of the fixed cover plate 7, and a pressing plane 7-5 is provided to level the base 1 and the fixed cover plate 7. Two second screw holes 7-6 of the fixed cover plate 7 are coupled with two first screw holes 1-4 of the base 1 through two self-tapping screws 8 shown in FIG. 8, respectively. The base 1 and the fixed cover plate 7 are coupled together, so that the rotating block 3 attached with the compressed sealing cotton piece 2 is able to be pressed on the base 1. In addition, the fixed cover plate 7 has a second toner discharge hole 7-3, which is coaxial with the toner outlet 1-7. FIG. 19 is an exploded view of the switch device according to this implementation. FIG. 20 is a structural diagram of the switch device according to the present application and the toner container after installation, and FIG. 21 is a cross-sectional view of FIG. 20.

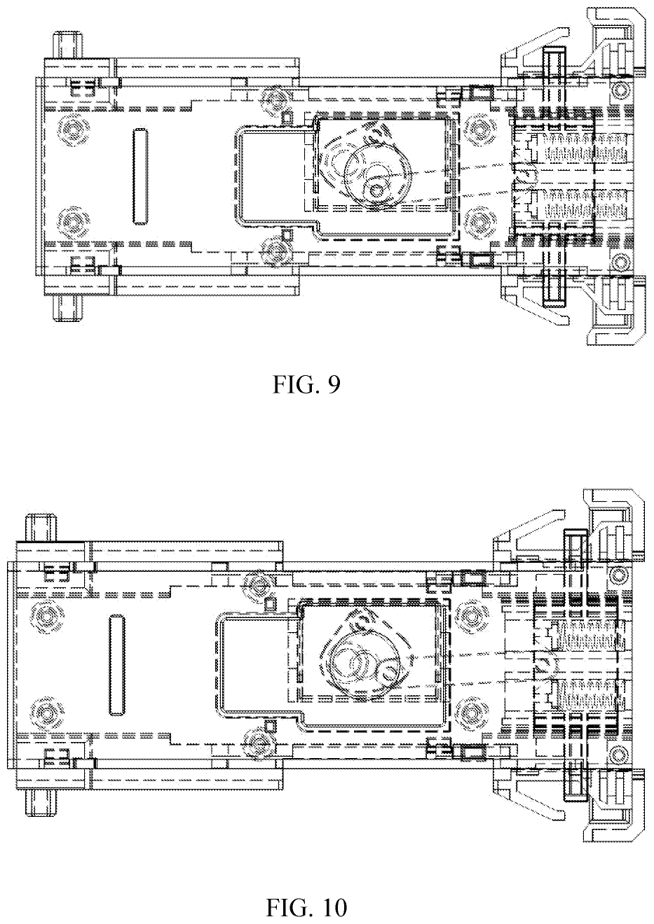

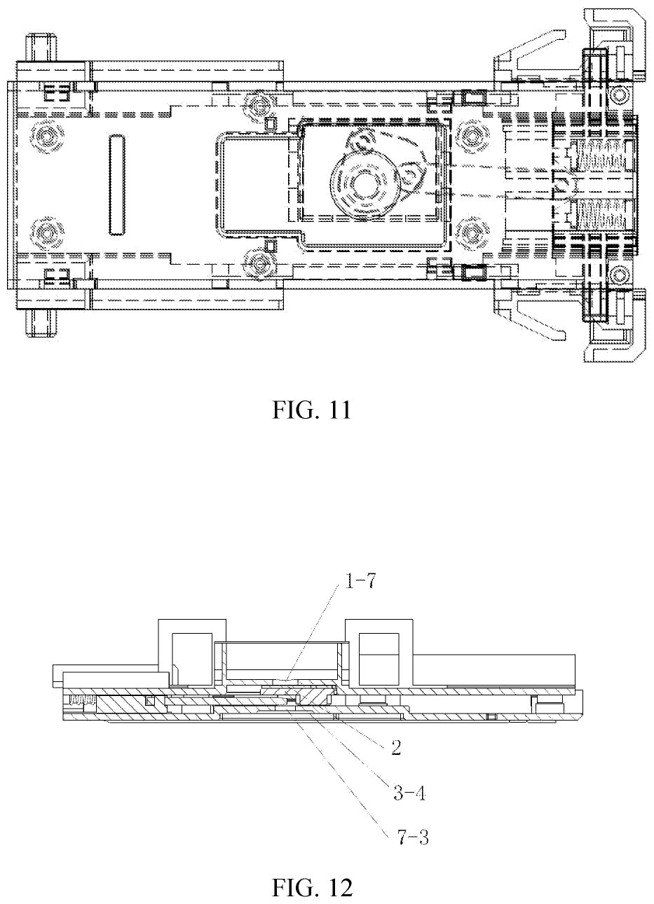

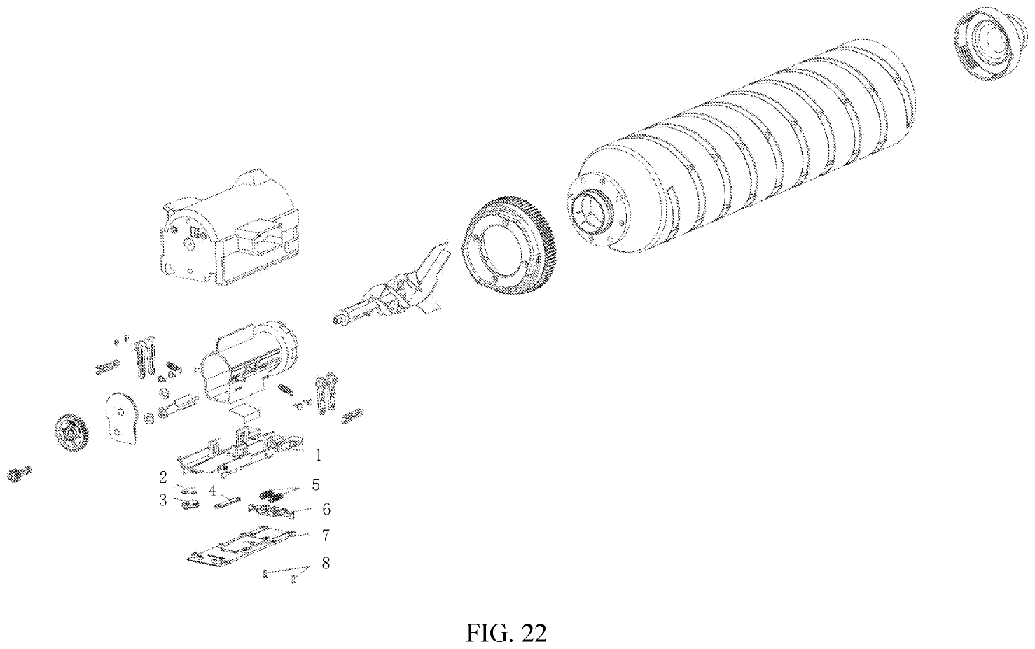

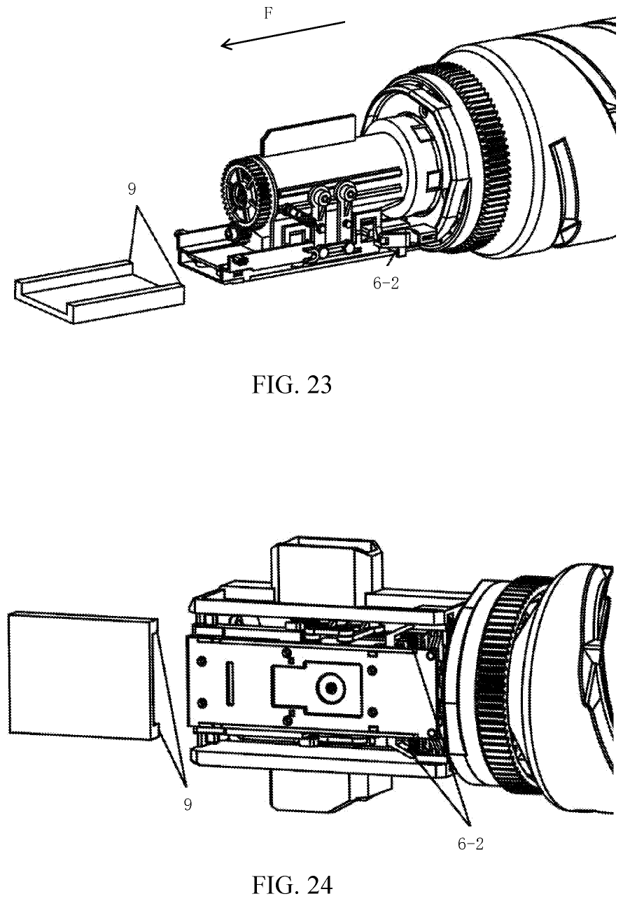

FIG. 22 shows an exploded view of the switch device according to the present application and the toner container. FIG. 23 shows a structural view of the toner container and the machine without outer casing. During the installation process of the toner container in the machine, a driving sliding plate holding portion 9 gradually contacts two second holding portions 6-3 of the driving sliding plate 6. Through the reaction force, as the toner container continues to be pushed in, the driving sliding block 6 will move in a direction opposite to the direction of loading the toner container into the machine (the reverse direction of arrow F); and by cooperating with the driving sliding block 6, the connecting rod 4 simultaneously moves opposite to the direction of installing the toner container (the reverse direction of arrow F). Since the connecting rod 4 is slidingly fitted with the rotating block 3, and the rotating block 3 is rotatably fitted on the second column 1-6, the rotating block 3 is able to rotate. When the connecting rod 4 moves, the rotating block 3 begins to rotate under force. FIG. 9 shows the initial state of the rotating block. As the toner container is continuously loaded into the machine, the rotating block is gradually stressed and gradually rotates to the position shown in FIG. 10 under the traction of the connecting rod 4, and finally rotates to the state shown in FIG. 11. During this process, every return spring 5 is compressed to the lowest position by every second spring holding plate 6-4 and every first spring holding plate 1-5. During the above rotation process, the toner outlet of the toner container is gradually opened.

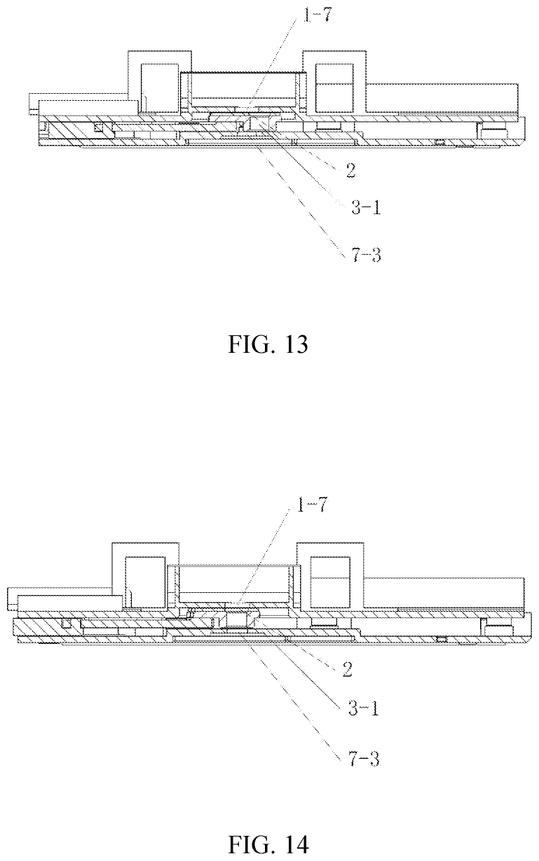

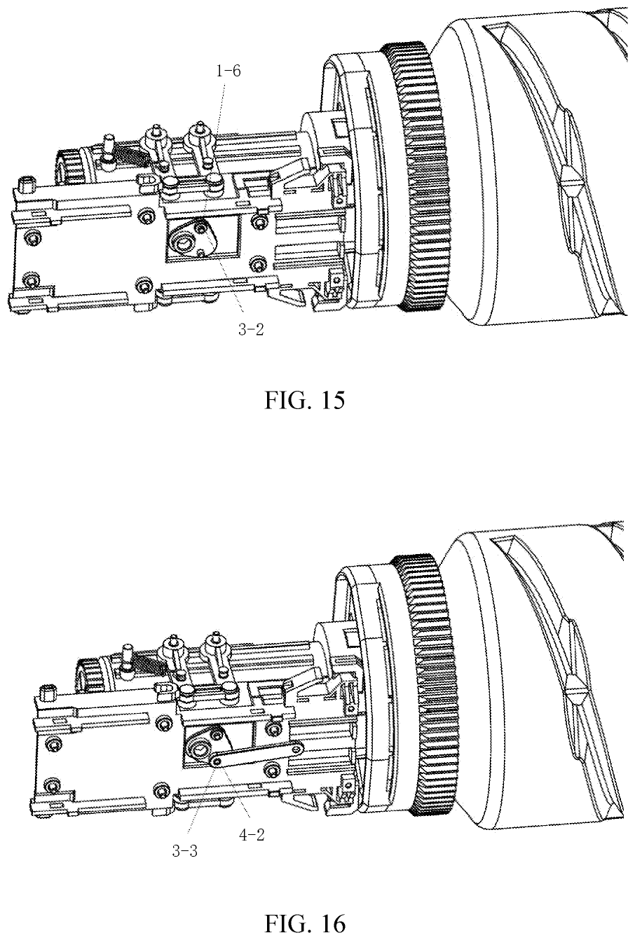

FIG. 12 shows the initial position of the rotating block 3. The toner outlet 1-7 is blocked by the rotating block plate part 3-4 of the rotating block 3 attached with the compressed sealing cotton piece 2. As the toner container is gradually installed into the machine, the rotating block 3 attached with the compressed sealing cotton piece 2 continues to rotate to the state shown in FIG. 13, and finally rotates to the state shown in FIG. 14, thereby realizing that the four holes, i.e., the toner outlet 1-7, the first toner discharge hole 2-1 of the compressed sealing cotton piece 2, the toner discharge channel 3-1 of the rotating block 3, and the second toner discharge hole 7-3 of the fixed cover plate 7, are coaxial with each other, so as to achieve a communication state. In this way, the toner inside the toner container is able to flow out through the toner port.

When the toner container is taken out from the machine, as shown in FIG. 24, the driving sliding plate holding portion 9 gradually separates from first holding portions 6-2 and second holding portions 6-3 of the driving sliding plate 6 of the machine, and every return spring 5 rebounds from the lowest position, caused by the compression of every second spring holding plate 6-4 and every first spring holding plate 1-5, to drive the driving sliding plate 6 and the connecting rod 4 to move in the direction of the elastic force of every return spring 5. The connecting rod 4 drives the rotating block 3 to rotate from the state of FIG. 14, through the state of FIG. 13, and finally to the state of FIG. 12, thereby realizing the closing function of the toner outlet 1-7.

The above-described embodiments are only preferred specific implementations of the present application. The phrases “in one embodiment”, “in another embodiment”, “in yet another embodiment” or “in other embodiments” mentioned in this specification may refer to one or more of the same or different embodiments according to the present disclosure. The usual changes and substitutions made by those skilled in the art within the scope of the technical solutions of the present application should be included in the protection scope of the present application.

1. A switch device for a toner port of a toner container, comprising:
a base (1) for accommodating the toner container, wherein the base (1) has a toner outlet (1-7);
a rotating block (3) having a toner discharge channel (3-1), wherein the rotating block (3) is rotatably coupled to the base (1); and
a driving sliding plate (6) for driving the rotating block (3) to rotate,
wherein the toner port of the toner container is opened when the rotating block (3) rotates to a position where the toner discharge channel (3-1) communicates with the toner outlet (1-7), and the toner port of the toner container is closed when the toner discharge channel (3-1) does not communicate with the toner outlet (1-7).

2. The switch device according to claim 1, further comprising:
a connecting rod (4), which has a first end coupled to the rotating block (3) for driving the rotating block (3) to rotate and a second end connected to the driving sliding plate (6).

3. The switch device according to claim 1, further comprising:
a compressed sealing cotton piece (2), which is attached on the rotating block (3), has a first toner discharge hole (2-1), and is located between the base (1) and the rotating block (3) after installation, wherein the first toner discharge hole (2-1) is coaxial with the toner discharge channel (3-1) of the rotating block (3).

4. The switch device according to claim 1, wherein the driving sliding plate (6) has a slide groove (6-1), the base (1) comprises a slide rail (1-3), and the slide rail (1-3) is inserted into the slide groove (6-1) to achieve sliding fit.

5. The switch device according to claim 1, further comprising:
a return spring (5), which is arranged between a second spring holding plate (6-4) of the driving sliding plate (6) and a first spring holding plate (1-5) of the base (1), and is compressed when the driving sliding plate (6) slides.

6. The switch device according to claim 4, further comprising:
a fixed cover plate (7), which is engaged with the base (1) and has a second toner discharge hole (7-3), wherein a compressed sealing cotton piece (2), the rotating block (3), a connecting rod (4) and the driving sliding plate (6) are located between the fixed cover plate (7) and the base (1), and the second toner discharge hole (7-3) of the fixed cover plate (7) is coaxial with the toner outlet (1-7) of the base (1).

7. The switch device according to claim 1, wherein the rotating block (3) comprises a rotating block plate part (3-4), and the toner outlet (1-7) of the base (1) is closed by the rotating block plate part (3-4) when the rotating block rotates to a position where the toner discharge channel (3-1) does not communicate with the toner outlet (1-7) of the base (1), so as to achieve closing the toner port of the toner container.

8. The switch device according to claim 1, wherein the driving sliding plate (6) comprises a first holding portion (6-2), at which the driving sliding plate (6) is driven to slide when the toner container is loaded.

9. The switch device according to claim 1, wherein the rotating block (3) has a circular shape, a fanned shape, a V-shape or other irregular shapes.

10. The switch device according to claim 5, wherein the return spring (5) is compressed when the toner container is loaded, and the return spring (5) is reset when the toner container is removed.

1. A switch device for a toner port of a toner container, comprising:
a base (1) for accommodating the toner container, wherein the base (1) has a toner outlet (1-7);
a rotating block (3) having a toner discharge channel (3-1), wherein the rotating block (3) is rotatably coupled to the base (1); and
a driving sliding plate (6) for driving the rotating block (3) to rotate, wherein the toner port of the toner container is opened when the rotating block (3) rotates to a position where the toner discharge channel (3-1) communicates with the toner outlet (1-7), and the toner port of the toner container is closed when the toner discharge channel (3-1) does not communicate with the toner outlet (1-7).

2. The switch device according to claim 1, further comprising:
a connecting rod (4), which has a first end coupled to the rotating block (3) for driving the rotating block (3) to rotate and a second end connected to the driving sliding plate (6).

3. The switch device according to claim 1, further comprising:
a compressed sealing cotton piece (2), which is attached on the rotating block (3), has a first toner discharge hole (2-1), and is located between the base (1) and the rotating block (3) after installation, wherein the first toner discharge hole (2-1) is coaxial with the toner discharge channel (3-1) of the rotating block (3).

4. The switch device according to claim 1, wherein the driving sliding plate (6) has a slide groove (6-1), the base (1) comprises a slide rail (1-3), and the slide rail (1-3) is inserted into the slide groove (6-1) to achieve sliding fit.

5. The switch device according to claim 1, further comprising:
a return spring (5), which is arranged between a second spring holding plate (6- 4) of the driving sliding plate (6) and a first spring holding plate (1-5) of the base (1), and is compressed when the driving sliding plate (6) slides.

6. The switch device according to claim 4, further comprising:
a fixed cover plate (7), which is engaged with the base (1) and has a second toner discharge hole (7-3), wherein a compressed sealing cotton piece (2), the rotating block (3), a connecting rod (4) and the driving sliding plate (6) are located between the fixed cover plate (7) and the base (1), and the second toner discharge hole (7-3) of the fixed cover plate (7) is coaxial with the toner outlet (1-7) of the base (1).

7. The switch device according to claim 1, wherein the rotating block (3) comprises a rotating block plate part (3-4), and the toner outlet (1-7) of the base (1) is closed by the rotating block plate part (3-4) when the rotating block rotates to a position where the toner discharge channel (3-1) does not communicate with the toner outlet (1-7) of the base (1), so as to achieve closing the toner port of the toner container.

8. The switch device according to claim 1, wherein the driving sliding plate (6) comprises a first holding portion (6-2), at which the driving sliding plate (6) is driven to slide when the toner container is loaded.

9. The switch device according to claim 1, wherein the rotating block (3) has a circular shape, a fanned shape, a V-shape or other irregular shapes.

10. The switch device according to claim 5, wherein the return spring (5) is compressed when the toner container is loaded, and the return spring (5) is reset when the toner container is removed.
